(19) United States
(12) Patent Application Publication
(10) Pub. No.: US 2019/0118152 A1
(43) Pub. Date: Apr. 25, 2019

(54) METHOD FOR PROCESSING FINE PARTICLES WITH A SPOUTED BED REACTOR

(71) Applicant: United States Department of Energy, Washington, DC (US)

(72) Inventors: Ronald W Breault, Moundsville, WV (US); David A Berry, Mount Morris, PA (US); Steven L Rowan, Morgantown, WV (US)

(21) Appl. No.: 16/163,823

(22) Filed: Oct. 18, 2018

Related U.S. Application Data
(60) Provisional application No. 62/573,750, filed on Oct. 18, 2017.

(51) Int. Cl. B01J 8/24; B01J 8/18

(52) U.S. Cl. CPC B01J 8/245; B01J 8/1809; B01J 8/1872; B01J 8/1836; B01J 8/1854; B01J 8/1827

(57) ABSTRACT

One or more embodiments relate to a contactor/separator vessel for reacting with fine particles. The contractor/separator vessel includes a spouted bed containing fine Geldart class C particles; and an additional spoutable media to facilitate spouting of the fine Geldart class C particles in order to improve mixing, gas-solid contact/separation.

### CROSS-REFERENCE TO RELATED APPLICATION

This application claims the benefit of and priority to U.S. Provisional Application 62/573,750 titled METHOD FOR PROCESSING FINE PARTICLES WITH A SPOUTED BED REACTOR filed Oct. 18, 2017, which is incorporated herein by reference in its entirety.

### STATEMENT OF GOVERNMENT SUPPORT

The United States Government has rights in this invention pursuant to an employer/employee relationship between the inventors and the U.S. Department of Energy, operators of the National Energy Technology Laboratory (NETL) and support agreements with contractors.

### FIELD OF THE INVENTION

Embodiments relate to converting or reducing solid materials. More specifically, embodiments relate to making unfluidizable Geldart Class C particles fluidizable by introducing spoutable media.

### BACKGROUND

Many industrial processes involve the conversion or reduction of solid materials via non-homogeneous reactions between the solid material and a surrounding gaseous or liquid medium. In the case of solid-gas reactions, fluidized beds are perhaps one of the most popular reactors due to the fact that the individual particles provide excellent surface contact for the desired reactions to take place.

However, not all types of solid particles may be easily fluidized. Large particles have large terminal velocities that must be overcome. Further very fine particles become more susceptible to inter-particle cohesion forces, such as Vander Waals, capillary and electrostatic forces. As a result of the actions of these forces, these cohesive particles (known as Geldart class C particles) tend not to fluidize. Instead, dense beads of cohesive particles tend to agglomerate, form cracks, or form channels through the bed of solids that allows the gas phrase to bypass the solids with very little contact between the two.

This behavior has in the past imposed limitations upon the minimum particle size for gas-solid reactions utilizing fluidized bed reactors. This forces a tradeoff between ease of fluidization and effective reaction rates within the gas-solid reaction system. This is because the smaller the particle diameter, the larger the ratio of its surface area-to-volume becomes, and the faster the apparent reaction rate between the solid and gas is.

As a consequence, the most common technology currently in use for reactions involving Geldart class C particles utilize either rotating drums (i.e., rotating kilns) or mechanical agitators to mix the process reactants, as well as vibrated fluidized beds (to break up the agglomerations of particles). However, these methods are not without their own limitation. These mechanical methods involve the use of moving parts operating at high temperatures, where the likelihood of mechanical failure increases; leading to increased maintenance and operating costs. Additionally, since these mechanical methods usually entail a dense bed of solids that are in direct contact with surrounding particles, there is less contact area between the solid and gas phases, which can lead to rate-limiting condition that reduces the extent of chemical conversion.

To address these issues, what is needed is a process through which the ability to fluidized cohesive Geldart class C particles is enhanced, thus removing the necessity for expensive reactor systems with moving parts that are prone to failure at high temperatures, as well as to improve the contact area between the solid and gas phases in a gas-solid non-homogeneous reaction.

### SUMMARY

Embodiments relate to combining a spoutable medium with fine Geldart C particles allowing for enhanced mixing and contact area between solid and gas-phase reactants, thus improving reaction yields.

One embodiment relates to providing a chemical reactor for fine Geldart class C particles, including a spouted bed; and an additional spoutable media to facilitate spouting of the fine Geldart class C particles in order to improve mixing and gas-solid contact and/or separation.

Another embodiment relates to a combination of a spoutable medium with fine Geldart C particles allowing for enhanced mixing and contact area between solid and gas-phase reactants, thus improving reaction yields.

Still another embodiment relates to a reactor that benefits from previously known and demonstrated advantages offered by spouted and/or fluidized beds over other mechanical reaction systems with moving parts operating at high temperatures; i.e. fewer mechanical failure points and maintenance costs.

Yet another embodiment relates to incorporating a spout-fluid bed instead of a spouted bed, where the difference between the two is a spout-fluid bed incorporates both a central gas jet and additional gas inlet distributor ports within the spout cone.

Yet another object relates to a modular design consisting of multiple reactors aligned side-by-side. In such a configuration, alternating reactor modules could in fact be combustion chambers in which a fuel (such as CH₄) is combusted in order to provide heat for adjacent reactor modules through a combination of convective and conductive heat transfer.

One embodiment relates to a contactor/separator vessel for reacting with fine particles, including a spouted bed containing fine Geldart class C particles; and an additional spoutable media to facilitate spouting of the fine Geldart class C particles in order to improve mixing, gas-solid contact/separation.

Yet another embodiment relates to a chemical reactor for reacting with fine particles, including a spouted bed containing fine Geldart class C particles; an additional spoutable media to facilitate spouting of the fine Geldart class C particles in order to improve mixing, gas-solid contact/separation; a gas distributor; and a spout where the gas distributor and spout assist with fluidization, flow rate and material transport.

One or more embodiments includes a chemical reactor wherein a temperature varies between about 150° C. and 1000° C. The chemical reactor may use a gas distributor and a spout to assist with one of a fluidization, flow rate and material transport, where the gas distributed through the gas distributor is pulsed.

Still other embodiments may include multiple spouting beds that are adjoined, where the multiple spouting beds are adjoined in a stacked and/or modular pattern. The multiple spouting beds are thermally controlled using heating chambers and/or thermally controlled using cooling chambers.

Other embodiments may include a spout bottom wherein the angle of the spotted bottom ranges from a horizontal to vertical orientation.

Other embodiments may include an internal design and operation promoting mixing and gas-solid contact and/or allowing for separation of various particle sizes and densities.

Other embodiments may include an internal design and operation promoting mixing and gas-solid contact and/or allowing for separation of various particle sizes and densities. An example of such internal design might take the form of one or more parallel plates or tubes, aligned axially to stabilize the gas jet within the reactor to improve spouting stability, facilitate increased solids inventory, as well as operation at lower gas velocities.

The following U.S. Patents and Patent Applications are incorporated herein by reference in their entirety:

U.S. Pat. No. 2,477,454 A to Heath discloses a process for reducing ferric Oxide to Ferrosoferric Oxide;

U.S. Pat. No. 4,021,193 A to Waters discloses spouted-fluidized bed reactor systems;

U.S. Pat. No. 4,379,186 A to Bush et al. discloses fluidizing fine particles;

U.S. Pat. No. 4,591,224 A to Araiza discloses a fluidization aid;

U.S. Pat. No. 4,583,299 A to Brooks discloses fluidization air for cohesive materials;

U.S. Pat. No. 5,674,308 to Meissner et al. which discloses a spouted bed circulating fluidized bed direct reduction system and method.

The following Articles are incorporated herein by reference in their entirety:

Geldart, D., Harnby, N., and Wong, A. C. (1984) titled Fluidization of Cohesive Particles, Powder Technology, Vol. 37, pp. 25-37;

Morooka, S., Kusakabe, K., Kobata, A., and Kato, Y. (1988) titled Fluidization State of Ultrafine Powders, J. of Chemical Engineering of Japan, Vol. 21, No. 1, pp 41-46;

Xu, C., and Zhu, J. (2005), titled Experimental and theoretical study on the agglomeration arising from fluidization of cohesive particles-effects of mechanical vibration, Power Technology, Vol 157, pp. 114-120;

Alavi, S., and Caussat, B. (2005), titled Experimental study on Fluidization of micronic powders, Powder Technology, Vol. 157, pp. 114-120;

Mawatari, Y., Masaya, T., Tatemoto, Y., and Noda, K. (2005), titled Favorable vibrated fluidization conditions for cohesive fine particles, Powder Technology, Vol 154, pp. 54-60;

Mawatari, Y., Koide, T., Tatemoto, Y., Uchida, S., and Noda, K. (2002), titled Effect of particle diameter on fluidization under vibration, Powder Technology, Vol. 123, pp. 69-74; and

Guo, Q., Liu, H., Shen, W., Yan, X., and Jia, R. (2006), titled Influence of sound wave characteristics on fluidization behaviors of ultrafine particles, Chemical Engineering Journal, Vol. 119, pp. 1-9.

### BRIEF DESCRIPTION OF THE DRAWINGS

The invention together with the above and other objects and advantages will be best understood from the following detailed description of the preferred embodiment of the invention shown in the accompanying drawings, wherein:

FIG. 1 depicts a typical spouted bed in accordance with one embodiment;

FIGS. 2A-2B depicted spouted beds where FIG. 2A depicts spoutability of fine magnetite while FIG. 2B depicts spoutability of fine magnetite mixed with glass beads at similar gas velocities;

FIGS. 3A-3C depict 2-D spouted beds where FIG. 3A depicts a 2-D spouted bed with a 45° spout for cold flow studies, FIG. 3B depicts a 2-D spouted bed with a 60° spout for cold flow studies, while FIG. 3C depicts a 2-D spouted bed with a 75° spout for cold flow studies;

FIG. 4 depicts one embodiment of a modular reactor arrangement; and

FIGS. 5A-5C depict spouted beds where FIG. 5A depicts a spouted bed with internal baffles for particle elutriation prevention, FIG. 5B depicts a spouted bed with pulsating gas injection inlets for agglomerate breakup and FIG. 5C depicts spouted bed with parallel baffles to promote spout jet stabilization and enhanced performance.

### DETAILED DESCRIPTION

The foregoing summary, as well as the following detailed description of certain embodiments of the present invention, will be better understood when read in conjunction with the appended drawings.

One embodiment relates to facilitating fluidization and mixing of fine and/or cohesive particles for the purpose of facilitating chemical reactions. In one example, embodiments could include the processing of fine hematite (Fe₂O₃) into magnetite (Fe₂O₄) via reduction with CH₄.

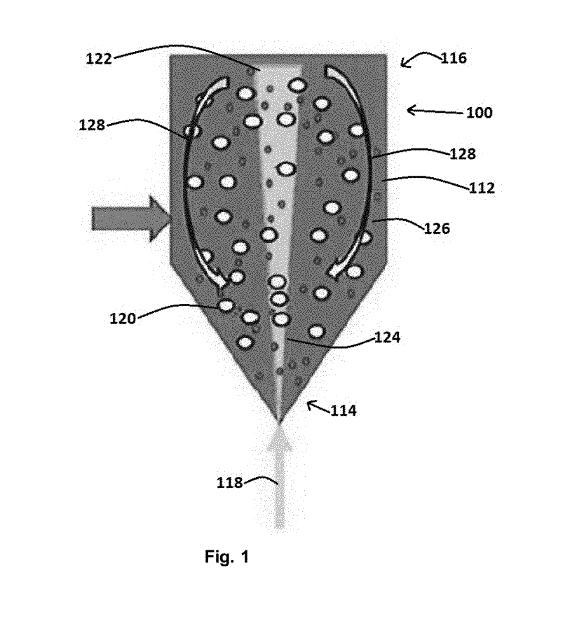

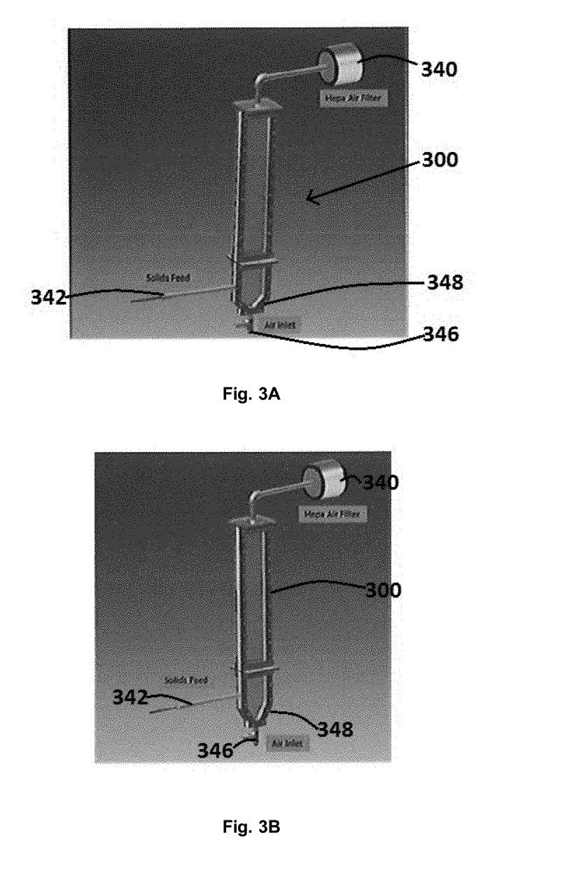

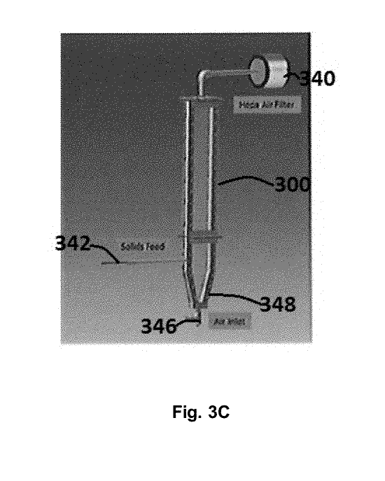

Embodiments relate to a chemical reactor for fine Geldart class C particles utilizing a spouted bed (such as those depicted in FIGS. 1 and 3A-3C) with additional spoutable media facilitating spouting of the fine particles in order to improve mixing and gas-solid contact. The temperature at which the reactor may operate varies depending upon the application. In an exemplary embodiment, drying may occur at 150° C., where production of magnetite may occur between 500-600° C., with the heat being provided by either electrical heating, or pre-heating of the spouting gas. Moreover, temperatures of up to 1000° C. are contemplated.

Embodiments relate to utilizing a spouted bed with a spoutable media to more easily fluidize the Geldart class C fine particles in order to improve mixing and contact area between the fluidizing gas and fine particles. FIG. 1 illustrates one embodiment of a typical spouted bed 100 having a housing 112. Housing 112 has a lower portion or bottom 114, typically conical in shape, and an opposing freeboard region 116.

In the illustrated spouted bed 100, a fluidizing gas 118 is injected into a dense bed of particulate material 120 located at the bottom 114 of the bed 100. The fluidizing gas 118 forms a jet that creates a core of upwards moving gas 122 within the bed of particles 120 that pushes the particles 124 located within the core 122 up through the densely-packed particles, until they are ejected from the bed of particles into the freeboard region 122 above the dense bed 120. The particles (assuming the gas velocity in the freeboard region 122 is less than the terminal velocity of the particles) then fall back down into the dense bed region.

In addition, as particles 124 are carried upwards throughout the core region 122 formed by the gas jet, additional particles are entrained into the bottom of the core 122 from the surrounding area, commonly referred to as the annulus 126, This produces a circulatory motion with the particles located in the annulus region 126, as depicted by the arrows 128 in FIG. 1.

As previously stated, Geldard class C particles are typically considered to be unfluidizable due to the dominance of inter-particle cohesive forces, leading to the fluidizing gas forming channels through the material, leaving the bulk of the solids fluidized. In at least one embodiment, it is necessary to make use of a second solid particulate material that is more readily fluidized (or spouted).

When this secondary particulate material (hereafter referred to as the ‘spoutable media’) is introduced into a bed of Geldart class C particles, the media interacts with the gas flow and begins to exhibit the spouted bed behavior provided above. As the spoutable media is ejected out of the core 122 and falls back into the annulus region 126, it collides with clumps (or clusters) of the more cohesive particles, breaking up these larger clusters. As the clusters of smaller, cohesive particles are broken up, the cohesive forces are overcome by other forces acting upon the particles, and they too eventually begin to exhibit spouting behavior within the bed.

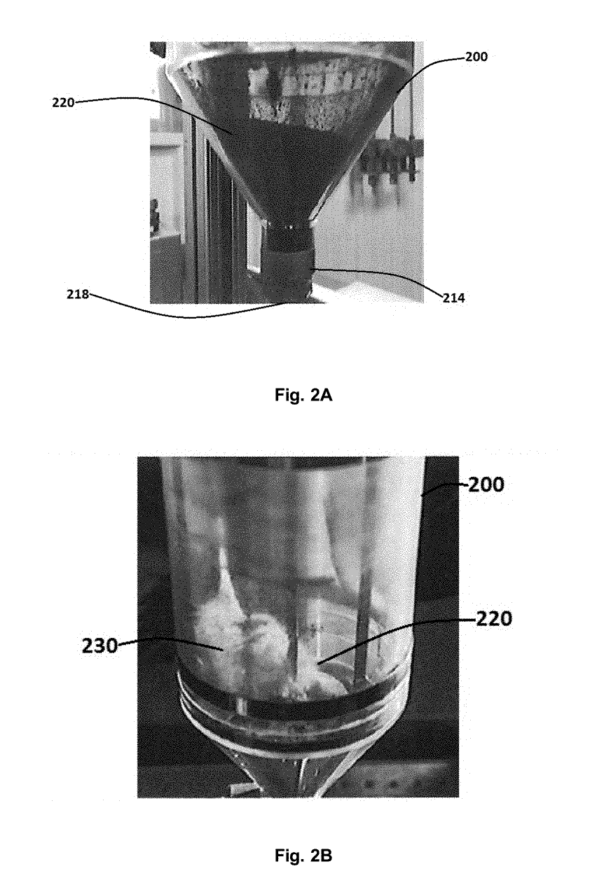

FIG. 2A depicts a spouted bed 200 loaded with fine magnetite (Fe₃Q₄) particles 220 of approximately 0.8 μm diameter is operated with air 218 being injected into the bottom 214 of the bed. As can be seen in FIG. 2A, no appreciable particle motion is evident. However, in FIG. 2B, 200 μm glass beads 230 have been added to the magnetite particles 220, and the spouting behavior may be clearly seen at a similar gas flow rate.

FIGS. 3A-3C depict small 2-D spouted beds 300 optimizing the spouting characteristics of cohesive Geldart class C particles mixed with a spoutable media under cold flow conditions. The illustrated embodiments of FIGS. 3A-3C include a hepa air filter 340, solid feed 342 and an air inlet 346. FIGS. 3A-3C demonstrate the effects of cone angle on the spouting characteristics, FIG. 3A depicts a 2-D spouted bed 300 with a 45° spout 348 for cold flow studies, FIG. 3B depicts a 2-D spouted bed 300 with a 60° spout 348 for cold flow studies, while FIG. 3C depicts a 2-D spouted bed 300 with a 75° spout 348 for cold flow studies. In at least one embodiment, it should be appreciated that different geometries from those shown may be used depending upon the given application.

One or more other embodiments may incorporate a spout-fluid bed instead of a spouted bed, where the difference between the two is the spout-fluid bed incorporates both a central gas jet and additional gas inlet distributor ports within the spout cone 348.

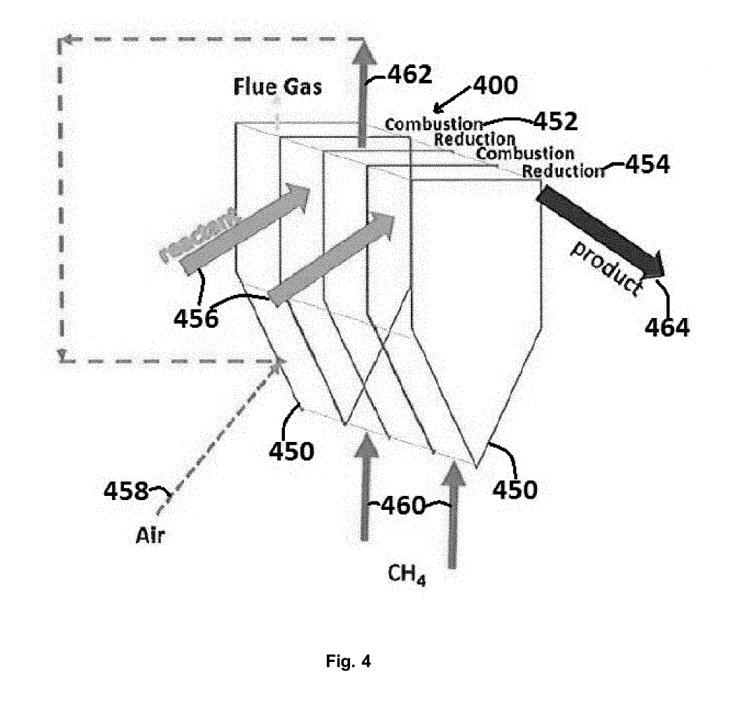

Still other embodiments illustrated in FIG. 4 for example could entail a modular design 400 consisting of multiple, adjoined, reactors 450 aligned side-by-side. In such a configuration, alternating reactors 450 could in fact be combustion chambers in which a fuel (such as CH₄) is combusted in order to provide heat for adjacent reactor modules through a combination of convective and conductive heat transfer (See FIG. 4).

As illustrated in FIG. 4 the modular design 400 includes alternating, adjoined, combustion reactors 452 and reduction reactors 454. As illustrated, the modular design 400 includes inputs ports for inputting or adding reactants 456, air 458 and fuel 460 (such as CH₄ for example). FIG. 4 illustrates ports for exhausting a flue gas 462 and the product 464. In at least one embodiment, the flue gas may be input back into a reactor via input port 458.

Still one or more embodiments relate to a reactor for solid-liquid and/or gas-liquid reactions utilizing submerged combustion.

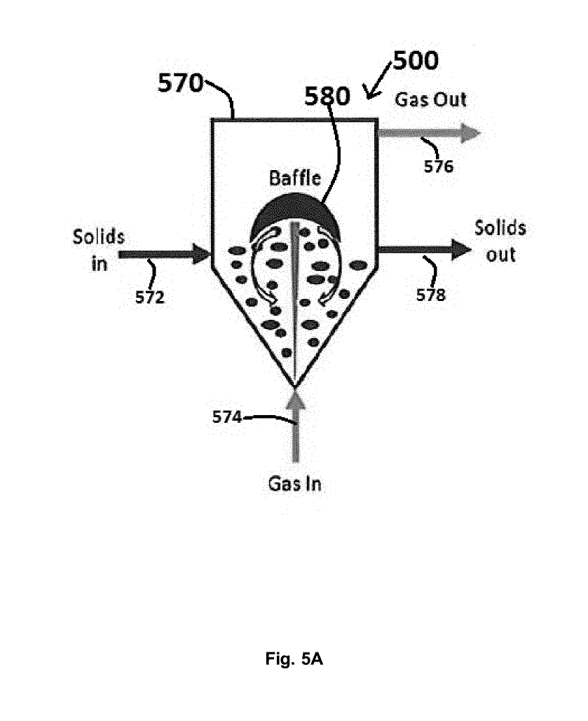

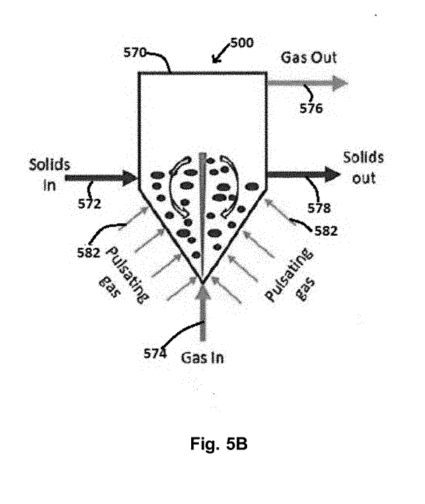

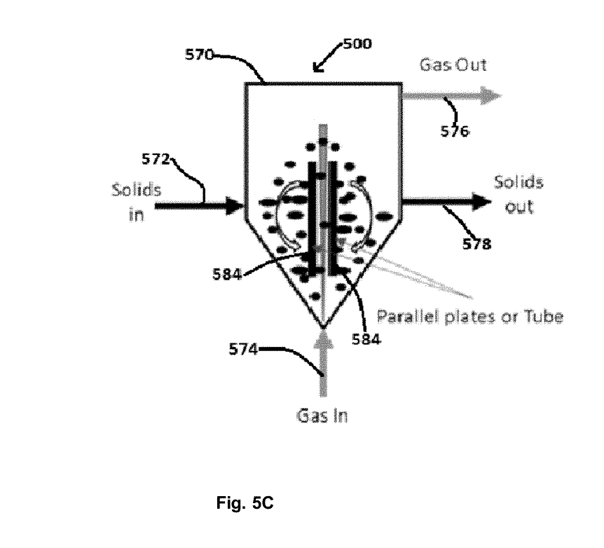

In addition to the embodiments provided above, other embodiments may include internal baffles to prevent particle entrainment and elutriation out of the reactor, or pulsating gas injection from the sides of the reactor in order to facilitate breakup of particle agglomerations (See FIGS. 5A-5C).

As illustrated in FIG. 5A the reactor 570 includes inputs ports for inputting or adding solids 572 and gas 574. FIG. 5A illustrates ports for exhausting a gas 576 and solids 578. FIG. 5A includes internal baffles 580 to prevent particle entrainment and elutriation out of the reactor 500.

As illustrated in FIG. 5B the reactor 570 includes inputs ports for inputting or adding solids 572 and gas 574. FIG. 5B illustrates ports for exhausting a gas 576 and solids 578. FIG. 5B includes pulsating gas injection 582 from the sides of the reactor 500 in order to facilitate breakup of particle agglomerations.

As illustrated in FIG. 5C the reactor 570 includes inputs ports for inputting or adding solids 572 and gas 574. FIG. 5C illustrates ports for exhausting a gas 576 and solids 578. FIG. 5C includes ore or more pairs or parallel plates 584 to promote spout jet stabilization and enhanced performance in the reactor 500 in order to facilitate breakup of particle agglomerations.

Additional embodiments may include particle drying, REDOX reactions of other metal oxides, solid-solid reactions (such as carbide formation), as well as reactions involving one or more liquid phase reactants in addition to gas- and solid phase reactants.

All numeric values are herein assumed to be modified by the term “about”, whether or not explicitly indicated. The term “about” generally refers to a range of numbers that one of skill in the art would consider equivalent to the recited value (e.g., having the same function or result). In many instances, the terms “about” may include numbers that are rounded to the nearest significant figure.

The recitation of numerical ranges by endpoints includes all numbers within that range (e.g., 1 to 5 includes 1, 1.5, 2, 2.75, 3, 3.80, 4, and 5).

The following detailed description should be read with reference to the drawings in which similar elements in different drawings are numbered the same. The drawings, which are not necessarily to scale, depict illustrative embodiments and are not intended to limit the scope of the invention.

As used herein, an element or step recited in the singular and preceded with the word “a” or “an” should be understood as not excluding plural said elements or steps, unless such exclusion is explicitly stated. As used in this specification and the appended claims, the term “or” is generally employed in its sense including “and/or” unless the content clearly dictates otherwise.

Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

In addition, many modifications may be made to adapt a particular situation or material to the teachings of the invention without departing from its scope. While the dimensions and types of materials described herein are intended to define the parameters of the invention, they are by no means limiting, but are instead exemplary embodiments. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the terms “comprising” and “wherein.” Moreover, in the following claims, the terms “first,” “second,” and “third,” are used merely as labels, and are not intended to impose numerical requirements on their objects. Further, the limitations of the following claims are not written in means-plus-function format and are not intended to be interpreted based on 35 U.S.C. § 112, sixth paragraph, unless and until such claim limitations expressly use the phrase “means for” followed by a statement of function void of further structure.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” “more than” and the like include the number recited and refer to ranges which can be subsequently broken down into subranges as discussed above. In the same manner, all ratios disclosed herein also include all subratios falling within the broader ratio.

One skilled in the art will also readily recognize that where members are grouped together in a common manner, such as in a Markush group, the present invention encompasses not only the entire group listed as a whole, but each member of the group individually and all possible subgroups of the main group. Accordingly, for all purposes, the present invention encompasses not only the main group, but also the main group absent one or more of the group members. The present invention also envisages the explicit exclusion of one or more of any of the group members in the claimed invention.

What is claimed is:

1. A contactor/separator vessel for reacting with fine particles, comprising:
a spouted bed containing fine Geldart class C particles; and
an additional spoutable media to facilitate spouting of the fine Geldart class C particles in order to improve mixing, gas-solid contact/separation.

2. The vessel of claim 1 comprising a chemical reactor wherein a temperature varies between about 150° C. and 1000° C.

3. The vessel of claim 2 wherein the chemical reactor uses a gas distributor and a spout to assist with at least one of fluidization, flow rate and material transport.

4. The vessel of claim 3 wherein a gas distributed through the gas distributor is pulsed.

5. The vessel of claim 2 further comprising multiple spouting beds are adjoined.

6. The vessel of claim 5 wherein the multiple spouting beds are adjoined in a stacked pattern.

7. The vessel of claim 5 wherein the multiple spouting beds are adjoined in a modular pattern.

8. The vessel of claim 5 wherein the multiple spouting beds are thermally controlled using heating chambers.

9. The vessel of claim 5 wherein the multiple spouting beds are thermally controlled using cooling chambers.

10. The vessel of claim 2 wherein the spouted bed includes an angle of a spout bottom wherein an angle of the spotted bottom ranges from a horizontal to vertical orientation.

11. The vessel of claim 2 having an internal design and operation promoting mixing and gas-solid contact.

12. The vessel of claim 1 having one or more pairs of parallel plates or tubes aligned axially in the vessel to stabilize a gas jet to improve spouting stability, facilitate increased solids inventory as well as promoting operation as lower gas velocities.

13. A chemical reactor for reacting with fine particles, comprising:
a spouted bed containing fine Geldart class C particles;
an additional spoutable media to facilitate spouting of the fine Geldart class C particles in order to improve mixing, gas-solid contact;
a gas distributor; and
a spout where the gas distributor and spout assist with fluidization, flow rate and material transport.

14. The chemical reactor of claim 13 wherein a temperature varies between about 150° C. and 1000° C.

15. The chemical reactor of claim 13 wherein a gas distributed through the gas distributor is pulsed.

16. The chemical reactor claim 13 further comprising multiple adjoined spouting beds.

17. The chemical reactor of claim 16 wherein the multiple spouting beds are adjoined in a one of a stacked and modular pattern.

18. The chemical reactor of claim 16 wherein the multiple spouting beds are thermally controlled using at least one of a heating and cooling chambers.

19. The chemical reactor of claim 13 wherein the spouted bed includes a spouted bottom, where the angle of the spout bottom ranges from a horizontal to vertical orientation.

20. The chemical reactor of claim 13 having an internal design and operation promoting mixing and gas-solid contact.

21. The chemical reactor of claim 13 having one or more pairs of parallel plates or tubes aligned axially in the vessel to stabilize a gas jet to improve spouting stability, facilitate increased solids inventory as well as promoting operation as lower gas velocities.
